(19) United States
(12) Patent Application Publication
(10) Pub. No.: US 2026/0178326 A1
(43) Pub. Date: Jun. 25, 2026

(54) BLOCK QUANTIZATION TECHNIQUES FOR PROCESSING-IN-MEMORY DEVICES

(71) Applicant: QUALCOMM Incorporated, San Diego, CA (US)

(72) Inventors: Subbarao Palacharla, San Diego, CA (US); Christopher Lott, San Diego, CA (US); Rui Cao, San Diego, CA (US)

(21) Appl. No.: 18/990,566

(22) Filed: Dec. 20, 2024

(51) Int. Cl. G06F 9/30; G06F 12/02

(52) U.S. Cl. CPC G06F 9/30036; G06F 9/30043; G06F 12/0207

(57) ABSTRACT

A processing-in-memory (PIM) device implements block quantization techniques for matrix-vector operations. The PIM device performs matrix-vector operations between portions of a weight matrix and an input vector, and copies results to a register. A read operation retrieves the copied results while additional matrix-vector operations are performed in parallel. The device may apply scaling factors to the results using multipliers within the PIM device. In some implementations, the weight matrix includes data columns and scaling factor columns interspersed at regular intervals. The scaling factors may be applied to accumulated results using parallel multiplication operations. Disclosed techniques enable efficient implementation of block quantization for applications such as Large Language Models while managing computational resources within the PIM architecture.

### TECHNICAL FIELD

This disclosure relates generally to processing-in-memory architectures, and more specifically, to block quantization techniques for efficient matrix-vector operations in processing-in-memory devices.

### BACKGROUND

Modern computing systems increasingly handle large-scale matrix computations, particularly in applications such as Large Language Models (LLMs). These computations often require significant memory bandwidth and computational resources. Processing-in-memory (PIM) architectures have emerged as a solution to address the memory bandwidth bottleneck by performing computations closer to where data resides. In PIM architectures, computational units are integrated within memory devices, such as Dynamic Random Access Memory (DRAM), to enable matrix-vector operations to be performed directly within the memory device. This approach can leverage higher memory bandwidth that is available inside the DRAM device compared to traditional architectures, i.e., where data must be transferred between memory and processor.

Large Language Models running on mobile or resource-constrained systems present unique challenges. Such systems can use reduced-precision weights (e.g., 4-bit weights) to minimize DRAM footprint due to memory configuration constraints imposed by power and cost considerations. Also, block quantization techniques are employed to map these smaller discrete values to a space of larger continuous values to maintain model accuracy while reducing memory requirements.

Implementing block quantization efficiently in PIM architectures, however, presents several challenges. The PIM logic area must be minimized to reduce power consumption and cost of the DRAM device. Additionally, the block quantization process should not significantly impact overall system throughput. Traditional approaches to block quantization often require substantial data movement between memory and processing units, leading to performance bottlenecks.

Further, existing block quantization implementations typically cannot efficiently handle the parallel processing capabilities of PIM architectures and/or may require complex control mechanisms that increase hardware overhead. The foregoing challenges become more pronounced when implementing hierarchical quantization methods that use different block sizes and scaling factors. Therefore, there is a need for improved techniques for implementing block quantization in PIM devices that can address these challenges while maintaining computational efficiency and accuracy.

### SUMMARY

The systems, methods and devices of this disclosure each have several innovative aspects, no single one of which is solely responsible for the desirable attributes disclosed herein.

One innovative aspect of the subject matter described in this disclosure can be implemented in a processing-in-memory (PIM) device. The PIM device performs one or more first matrix-vector operations between a first portion of a weight matrix and an input vector, copies results of these operations to a register, initiates a read operation for the copied results from the register, and performs one or more second matrix-vector operations between a second portion of the weight matrix and the input vector in parallel with the read operation.

In some examples, the device applies a quantization factor to the copied results read from the register. The weight matrix may be organized into one or more first blocks of a first size, with one or more of these first blocks grouped into one or more second blocks of a second size, where the second size is larger than the first size. Each second block may comprise between 256 and 1024 values from the weight matrix. The weight matrix may comprise weight values of a first bit-width, while the input vector comprises values of a second bit-width different from the first bit-width, where the first bit-width may be 4 bits and the second bit-width may be 8 bits. The device may obtain one or more scaling factors in a scale register and scale results using a multiplier within the PIM device. The weight matrix may include data columns and scaling factor columns, with scaling factors loaded and applied to results within the PIM device. The scaling factor columns may be interspersed among the data columns at regular intervals. When copying results to the register, an accumulator used for the matrix-vector operations may be automatically cleared.

Another innovative aspect of the subject matter can be implemented in a method for quantization in a PIM device. The method includes performing one or more matrix-vector operations between portions of a weight matrix and an input vector, accumulating results of these operations, applying one or more scaling factors to the accumulated results using a multiplier in the PIM device, and outputting one or more scaled results associated with the scaling factors.

In some examples, applying the scaling factors includes sequentially processing entries in an accumulator using the multiplier, which may comprise an integer multiplier shared among multiple processing units. The scaled results may comprise quantized values associated with a block of weight matrix columns.

Another innovative aspect of the subject matter can be implemented in a method for quantization in a PIM device that includes storing a weight matrix in the PIM device, where the weight matrix includes one or more data columns and one or more scaling factor columns. The method includes performing one or more matrix-vector operations between the data columns and an input vector, accumulating results of these operations, loading scaling factors from the scaling factor columns, and applying the loaded scaling factors to the accumulated results within the PIM device.

In some examples, applying the loaded scaling factors includes using a multiplier to sequentially process the accumulated results with corresponding scaling factors, or performing parallel multiplication using multiple integer multipliers. The input vector may comprise 16-bit integer values, while the data columns may comprise 4-bit weight values and the scaling factor columns may comprise 32-bit values. The scaling factor columns may be interspersed among the data columns at regular intervals of 60, with 4 scaling factor columns for every 60 data columns. The method may include selecting scaling factors associated with a current block of data columns being processed, where applying the loaded scaling factors produces quantized output values for a block of the weight matrix.

These and other implementations may each optionally include one or more of the following features. For instance, various implementations may include one or more of: parallel processing capabilities, different memory configurations, various block sizes, different bit-width combinations, and different scaling factor arrangements.

The various aspects, implementations, and features disclosed herein may be implemented in a variety of ways. For example, aspects may be implemented as a device, such as a processing-in-memory device, a memory controller, or an integrated circuit. Aspects may also be implemented as one or more methods or processes. Further, aspects may be implemented as instructions stored in a computer-readable storage medium that, when executed by one or more processors, cause the processors to perform the disclosed operations. Such computer-readable storage media may include, but are not limited to, random access memory (RAM), read-only memory (ROM), electrically erasable programmable read-only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium capable of storing instructions for execution by processors.

The various aspects may also be implemented in hardware, software, firmware, or any combination thereof. For instance, aspects may be implemented as dedicated circuits or logic configured to execute the described functionality. Alternatively or additionally, aspects may be implemented as programs, modules, routines, or other software components executed by one or more processors. In some implementations, aspects may be implemented using application-specific integrated circuits (ASICs), field-programmable gate arrays (FPGAs), or other programmable logic devices.

The details of one or more implementations are set forth in the accompanying drawings and description below. Other features and advantages will be apparent from the description and drawings, and from the claims. It is to be understood that both the foregoing general description and the following detailed description are exemplary and explanatory only and are not restrictive of the invention, as claimed. Features shown in the various figures can be combined and/or modified in ways not explicitly shown, while remaining within the scope of the claims.

### DESCRIPTION OF THE FIGURES

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of a processing-in-memory system that can be configured for performing efficient matrix computations and block quantization according to one or more aspects of this disclosure.

FIG. 2A shows a block diagram illustrating a basic PIM DRAM architecture that can support matrix-vector multiplication and block quantization according to one or more aspects of this disclosure.

FIG. 2B shows an operational flow diagram illustrating matrix-vector multiplication processes within the PIM DRAM architecture according to one or more aspects of this disclosure.

FIG. 3 shows a flow chart of an example method performed by a PIM device for implementing snapshot-based parallel processing for block quantization according to one or more aspects of this disclosure.

FIG. 4 shows a flow chart of an example method performed by a PIM device for implementing internal scaling operations for block quantization according to one or more aspects of this disclosure.

FIG. 5 shows a flow chart of an example method performed by a PIM device for implementing embedded scaling factors for block quantization according to one or more aspects of this disclosure.

FIG. 6 shows a block diagram of an example PIM device configured to implement snapshot-based parallel processing for block quantization according to one or more aspects of this disclosure.

FIG. 7 shows a block diagram of an example PIM device configured to implement internal scaling operations for block quantization according to one or more aspects of this disclosure.

FIG. 8 shows a block diagram of an example PIM device configured to implement embedded scaling factors for block quantization according to one or more aspects of this disclosure.

Like reference numbers and designations in the various drawings indicate like elements.

### DETAILED DESCRIPTION

The present disclosure provides systems, apparatus, methods, and computer-readable media that support improved processing-in-memory operations, such as techniques for efficient block quantization in processing-in-memory devices using hierarchical scaling and parallel processing capabilities.

Shortcomings of previous techniques mentioned here are only representative and are included to highlight problems that the inventors have identified with respect to existing processing-in-memory devices and sought to improve upon. Traditional block quantization in mobile systems requires significant memory bandwidth and computational resources when, e.g., implementing Large Language Models. Moreover, existing implementations often struggle to efficiently handle reduced-precision weights while maintaining model accuracy, especially in resource-constrained environments. Aspects of devices described below may address some or all of these shortcomings as well as others known in the art. Aspects of the improved devices described herein may present other benefits than, and be used in other applications than, those described above.

The detailed description set forth below, in connection with the appended drawings to which the text references, is intended as a description of various embodiments and is not intended to limit the scope of the disclosure. Rather, the detailed description includes specific details for the purpose of providing a thorough understanding of the subject matter of this disclosure. It will be apparent to those skilled in the art that these specific details are not required in every case and that, in some instances, well-known structures and components are shown in block diagram form for clarity of presentation.

In the description of embodiments herein, numerous specific details are set forth, such as examples of specific components, memory devices, and processes to provide a thorough understanding of the present disclosure. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a processing-in-memory device.

Aspects of this disclosure involve techniques for implementing block quantization in processing-in-memory architectures to enable efficient matrix-vector operations with reduced memory requirements. By performing quantization operations within the memory device itself, implementations can minimize data movement between memory and processing units. To that end, implementations described herein encompass approaches to quantization in processing-in-memory devices. According to certain aspects, the described techniques perform matrix-vector operations while managing results through an efficient register system that enables parallel processing. Processing-in-memory devices described herein can receive and interpret scaling factors and apply them either through dedicated registers or as embedded values within the weight matrix itself. Multiple multiplication units within the processing-in-memory device can operate in parallel, handling both matrix-vector operations and scaling factor applications. Matrix operations proceed continuously while results are being read, maximizing computational throughput.

Implementations involve various aspects of quantization management that contribute to efficient processing. For instance, disclosed techniques organize weight matrices into hierarchical blocks of different sizes, allowing for flexible scaling factor application. Matrix values can be stored in reduced precision format, such as 4-bit weights, while input vectors may use different precision levels suited to their requirements. Advanced mechanisms identify optimal arrangements for scaling factors, whether stored separately in registers or embedded within the weight matrix. Implementations support both sequential and parallel multiplication operations to adapt to different computational requirements.

The processing-in-memory devices described herein can also implement sophisticated data management techniques to maintain efficient operation. Results from matrix-vector operations are copied to registers-allowing subsequent operations to proceed in parallel with result reading. Scaling factors can be arranged at regular intervals within the weight matrix to reduce the overhead of factor application. Further, accumulator management ensures efficient handling of partial results with automatic clearing mechanisms maintaining continuous processing flow. Such implementations enable processing-in-memory devices to handle complex quantization operations while minimizing memory bandwidth requirements and computational overhead.

Particular implementations of the subject matter described in this disclosure may be implemented to realize one or more of the following potential advantages or benefits. In some aspects, the present disclosure provides techniques for significantly reducing memory bandwidth requirements in processing-in-memory operations. By performing quantization operations within the memory device itself the system minimizes data movement between memory and processing units. The parallel processing capabilities, combined with efficient register usage, allow for continuous computation while results are being read. Integration of scaling factor storage and application within the memory device eliminates separate data transfer operations that would otherwise consume bandwidth and processing time.

The organization of weight matrices into hierarchical blocks with associated scaling factors enables efficient handling of reduced-precision weights. Rather than requiring full-precision storage throughout the system, weights can be stored in reduced precision (e.g., 4-bit) format and scaled appropriately during computation. This approach substantially reduces memory footprint while maintaining computational accuracy. The ability to embed scaling factors within the weight matrix itself further reduces overhead by eliminating separate data transfers for scaling operations. Implementations can process large language models with significantly reduced memory requirements thereby making complex AI applications feasible on mobile and resource-constrained devices.

Flexibility in implementation provides benefits across different system configurations. The ability to perform both sequential and parallel multiplication operations allows systems to balance computational resources against performance requirements. Systems can choose between dedicated register-based scaling factor storage or embedded scaling factors within the weight matrix, optimizing for their specific hardware constraints. Support for varying block sizes and scaling factor arrangements enables fine-tuned optimization for different types of neural network architectures and memory configurations. Processing-in-memory devices can adapt their operation based on available resources and specific application requirements.

The parallel processing capabilities of disclosed implementations can deliver significant performance improvements. Multiple multiplication units operating simultaneously can process matrix operations and apply scaling factors without creating bottlenecks. The register-based result management system enables continuous processing while maintaining data consistency. Automatic accumulator clearing mechanisms eliminate additional overhead operations that would otherwise interrupt processing flow. The foregoing features combine to create a highly efficient processing environment within the memory device itself.

Disclosed techniques provide notable advantages in system design flexibility. Implementations can accommodate different precision requirements for weight matrices and input vectors to allow optimization for specific applications. The ability to intersperse scaling factors at regular intervals within weight matrices provides predictable access patterns and efficient scaling operations. Support for both sequential and parallel processing enables systems to scale from small, energy-efficient configurations to high-performance implementations without changing the fundamental architecture.

According to certain aspects, the present disclosure implements optimized block quantization techniques within a Processing-in-Memory (PIM) architecture. The techniques are relevant to a number of applications, including the implementation of Large Language Models (LLMs) in mobile or resource-constrained environments.

An operation in the quantization techniques can be represented as a dot product of 32 elements from an activation vector (A) and a weight matrix (W), expressed as: Σ(i=1 to 32) Aᵢ*Wᵢ. This operation forms the basis for two distinct optimization approaches, each balancing computation between the PIM device and the controller in different ways. In a first approach, referred to as “Min in Controller,” the operation is expanded as follows in equation 1:

$${\sum }_{i = 1}^{32} {A}_{i} {W}_{i} = {a}_{f} {\sum }_{i = 1}^{32} {a}_{i} ( s f * {w}_{i} + o ) = {a}_{f} ( {s}_{f} {\sum }_{i = 1}^{32} {a}_{i} {w}_{i} + o {\sum }_{i = 1}^{32} {a}_{i} ) = {a}_{f} ( d {l}_{s} {\sum }_{i = 1}^{32} {a}_{i} {w}_{i} + {d}_{min} {l}_{h} {\sum }_{1 = 1}^{32} {a}_{i} )$$

Here, a_{f} represents an activation scale factor, sf is a weight scale factor, and o is an offset. The terms d and dₘᵢₙ are “superblock” scale factors, while lₛ and lₕ are block scale factors, with Is specifically being a power of 2. This first approach separates the block dot product of weights and offsets, converting each to floating point using different superblock scales (d and dₘᵢₙ) before combining them for the final floating-point result.

A second approach, termed “Min on PIM,” modifies the computation as follows in equation 2:

$${\sum }_{i = 1}^{32} {A}_{i} {W}_{i} = {a}_{f} {\sum }_{i = 1}^{32} {a}_{i} ( s f * {w}_{i} + o ) = {a}_{f} ( {s}_{f} {\sum }_{i = 1}^{32} {a}_{i} {w}_{i} + o {\sum }_{i = 1}^{32} {a}_{i} ) = {a}_{f} d ( {l}_{s} {\sum }_{i = 1}^{32} {a}_{i} {w}_{i} + f * {l}_{h} {\sum }_{1 = 1}^{32} {a}_{i} )$$

As seen, the second approach differs in that it performs the block dot product of weights and offsets together within the integer domain of the PIM device. The result is then converted to floating point using a single superblock scale factor (d). Doing so potentially improves computational efficiency by leveraging the PIM's integer arithmetic capabilities more extensively.

It should be noted that in the “Min on PIM” approach, the choice of lₕ can be important to ensure correct scaling. Empirical testing has shown that setting f=16 in the equation lₕ=2\hat{ }f works effectively in many scenarios.

These optimization techniques align with embedding scaling factors within the weight matrix. By distributing computation between the PIM device and the controller the foregoing approaches enable efficient implementation of block quantization. This is particularly true in the context of LLMs on mobile or embedded systems or otherwise, i.e., where performance and energy efficiency are primary goals.

As seen, the foregoing techniques enable quantization operations within the PIM architecture that reduce data movement and improve efficiency. Further, the techniques can be beneficial when implemented in conjunction with the parallel multiplication techniques and the hierarchical block structure described herein. Implementations can also include specific execution sequences for matrix-vector multiplication operations. For example, a device can output Y through a sequence comprising: one Write Vector (WrV) operation to load the input vector into PIM, 32 Load & MAC (LdMAC) operations performed one matrix column at a time and one Load Accumulator (LdACC) operation to read the result. This sequence operates on matrices where data (e.g., 1 KB) resides in the same row of the same bank.

Described architectures support multiple configurations for weight and vector representations. For example, in one implementation, a 64×64 matrix multiplication uses 1-byte vectors and 4-bit weights, processing 32-byte chunks at a time. Alternative configurations include 32×32 matrices with similar precision arrangements, demonstrating the flexibility of the architecture.

Regarding hardware implementation, PIM units described herein can include multiply-accumulate (MAC) units that support various bit-width combinations. For instance, 4×8 multipliers handle 4-bit weights and 8-bit activation values, feeding into an 18-bit accumulator. The design employs an 8×18 multiplier for scaling operations, with results stored in a 32-bit accumulator. This hierarchical structure efficiently manages different precision requirements at various stages of computation.

Bl block quantization can be implemented through multiple approaches—each with specific overhead characteristics. For example, when using INT8 multipliers, implementations can embed 4 columns of scaling factors for every 60 columns of weight matrix, thereby achieving a reduced overhead of approximately 7% through parallel multiplication operations. This approach employs 32 INT8×INT8 multipliers with MAC units supporting INT4×INT8 operations and a 32×8b vector register configuration.

In furtherance of the foregoing concepts, according to an aspect, a processing-in-memory system can be configured to implement block quantization through an accumulator-based approach. The system can include a DRAM bank that may be configured to store a matrix (for example, a 32×32 matrix of 0.5 KB), a MAC unit that can be coupled to the DRAM bank, and an accumulator that may be configured to store intermediate results. The system can further include a snapshot register that may be configured to store copies of accumulator contents.

In operation, the system can be configured to read the accumulator contents after processing a predetermined number of matrix columns. For example, when processing a 32×128 matrix (comprising 4 columns of matrix M), the system may perform 4 Write Vector (WrV) operations, 64 Load & MAC (LdMAC) operations (calculated as 4×16), and 32 Load Accumulator (LdACC) operations. The system can be configured to apply a quantization factor to the read sum and accumulate the quantized result into a final output Y.

To reduce operational overhead, which may be approximately 47% in some implementations (calculated as 32/(4+64)), the system can implement several optimization techniques. A snapshot mechanism can be incorporated where the accumulator can be configured to snapshot its contents into a shadow copy. This approach can enable overlapping of partial result reads with subsequent matrix LdMAC operations.

The system can be further configured such that the last LdMAC operation automatically clears the accumulator. In particular, the last LdMAC operation can be configured to compute a final accumulator value, snapshot the accumulator contents into the shadow copy, and zero out the accumulator for the next GEMV (General Matrix-Vector) computation. This automatic clearing mechanism can eliminate the need for separate clearing operations that otherwise introduce additional overhead.

The accumulator and snapshot mechanism can be implemented using various register configurations. For example, the system can employ a vector accumulator coupled to both the MAC unit and a snapshot register. The snapshot register can be configured to maintain a copy of accumulator contents while new matrix-vector operations proceed, enabling parallel processing that can substantially reduce overall computational overhead.

This implementation can be particularly effective when processing weight matrices organized in blocks, where each block may comprise multiple columns that can be processed sequentially while maintaining parallel operation through the snapshot mechanism. The system can be configured to manage scaling factors that may be applied either during the accumulation process or during the final result computation, providing flexibility in how quantization is implemented.

According to another aspect, a processing-in-memory system can be configured to implement block quantization through an internal scaling approach. The system can include a DRAM bank that may be configured to store a matrix (for example, a 32×32 matrix of 0.5 KB), a MAC unit that can be coupled to the DRAM bank, and a scale register that may be configured to store scaling factors downloaded from an ML processor or other controller.

In operation, the system can be configured to perform quantization operations inside the PIM device using downloaded scaling factors. For example, when processing a 32×128 matrix (comprising 4 columns of matrix M), the system may perform 4 Write Vector (WrV) operations and 64 Load & MAC (LdMAC) operations (calculated as 4×16). The system can be further configured to process Write Scale (WrSCALE) operations, which may involve writing scaling factors for 32 rows, where each scaling factor can be a 4-byte value (WA scale) across 16 banks, potentially resulting in 128B*16=64 (32B writes).

To manage computational operations, the system can include an INT32 multiplier that may be configured to process scaling operations. The multiplier can be implemented as a shared resource among multiple processing units in the PIM device, with operations potentially being performed in a sequential manner through the multiplier. The system can be configured such that a single INT32 multiplier loops through accumulated results, applying appropriate scaling factors to each.

This aspect can further include a snapshot mechanism similar to the foregoing aspect where an accumulator can be configured to snapshot its contents into a shadow copy. This snapshot capability can enable efficient management of intermediate results during the scaling process. The scale register can be configured to maintain scaling factors throughout the processing of a given matrix block, potentially reducing the frequency of scaling factor downloads.

While this implementation may involve additional write overhead (approximately 94%, calculated as 64/(4+64) in some implementations), it can offer advantages in terms of reduced data movement for scaling operations and potential simplification of the external processing requirements. Here, the system can be configured to balance these considerations based on specific application requirements and hardware constraints. Further, the area requirements for this implementation can include space for the INT32 multiplier and associated scale register circuitry. However, by sharing the multiplier among multiple processing units and implementing efficient control mechanisms, the overall hardware overhead can be managed while maintaining computational efficiency.

According to yet another aspect, a processing-in-memory system can be configured to implement block quantization through embedded scaling factors within the weight matrix itself. The system can include (1) a DRAM bank that may be configured to store a matrix (for example, a 32×32 matrix of 0.5 KB) with embedded scaling factor columns, (2) a MAC unit that can be coupled to the DRAM bank, and (23) processing elements that may be configured to handle both weight values and scaling factors. In operation, the system can be configured to embed scaling factors directly within the weight matrix structure, where, e.g., 4 columns of scaling factors can be interspersed every 60 columns of weight matrix data. The system can be configured to process input vectors comprising INT8 (8-bit integer) values and can perform quantization operations inside the PIM device. The MAC units can be designed to support INT4 (4-bit integer) by INT8 operations, providing efficient handling of reduced-precision calculations. A Load & Scale (LdScale) operation can be issued by an ML Processor, wherein scaling factors may be loaded directly from the DRAM bank.

The system can be configured to support independent weight scaling and activation scaling operations. For timing management, the system can implement a load sequence where scaling factors may require 4*tCCDL for loading operations. When configured with a single INT8 multiplier, scaling operations can involve 32*1 INT8 per tCCDL, potentially resulting in an overhead of approximately 53%. Alternatively, when configured with two INT8 multipliers, the system can achieve reduced overhead of approximately 27%.

The hardware implementation can be configured to include one or more INT8 multipliers where the MAC units can be designed to support INT4×INT8 operations. The system can include a vector register that may be configured as a 32×8b storage element. Unlike previous aspects, this implementation can be configured to operate without requiring a snapshot register-potentially simplifying hardware architecture.

Notably, the system can be configured for parallel multiplication operations using multiple integer multipliers within the PIM device. In particular implementations, the system can employ up to 32 INT8×INT8 multipliers operating in parallel, potentially reducing the time overhead of scaling operations to approximately 7%. The parallel multiplication capabilities can be selectively enabled or disabled based on performance requirements and power constraints. The foregoing embedded scaling factor aspect can provide efficient access patterns for scaling operations, as scaling factors are stored physically adjacent to the weight values they scale. Finally, the system can be configured to manage the relationship between data columns and scaling factor columns, maintaining the 4:60 ratio while allowing for flexible implementation of the scaling operations themselves.

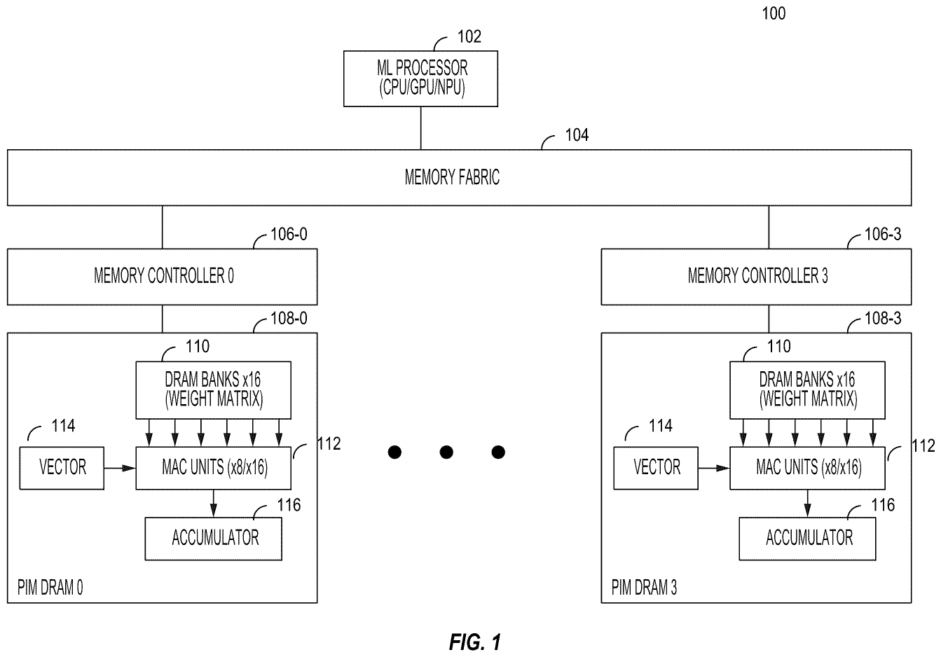

FIG. 1 illustrates a block diagram of a processing-in-memory system 100 that enables computation directly within memory devices according to aspects described herein. System 100 includes a machine learning (ML) processor 102, which may be implemented using various processing architectures. For example, processor 102 may comprise a central processing unit (CPU), graphics processing unit (GPU), neural processing unit (NPU), application-specific integrated circuit (ASIC), or combinations thereof. ML processor 102 can be configured to manage high-level operations, distribute computational tasks, and coordinate processing across memory devices.

A memory fabric 104 couples to ML processor 102 and enables data movement and processing capabilities. Memory fabric 104 can be specialized to support various processing-in-memory operations through command handling, routing protocols, and synchronization mechanisms. The fabric 104 may implement different interconnect technologies and topologies depending on system requirements, including point-to-point connections, crossbar switches, or mesh networks.

Memory fabric 104 connects to multiple memory controllers 106 (illustrated as controllers 106-0 through 106-3 in one implementation, though other quantities may be implemented). Each memory controller 106 can be configured to support processing-in-memory commands and operations beyond traditional memory access patterns. Controllers 106 may implement specialized command queues, reordering logic, and timing control to manage both conventional memory operations and processing-in-memory functions. Different implementations may employ varying numbers of controllers based on factors such as system size, bandwidth requirements, and power constraints.

Each memory controller 106 couples to a corresponding processing-in-memory DRAM (PIM DRAM) device 108. While four PIM DRAM devices (108-0 through 108-3) are shown, systems may scale from single devices to large arrays of devices. Each PIM DRAM 108 includes multiple DRAM banks 110, which may be implemented in various configurations (for example, eight, sixteen, or thirty-two banks per device). The DRAM banks 110 can be configured to store different types of data, including weight matrices for neural network computations, activation values, or general computational data structures. DRAM Banks 110 may be organized into different zones or regions optimized for specific access patterns or computational requirements.

Within each PIM DRAM 108, multiply-accumulate (MAC) units 112 couple to DRAM banks 110 and can be configured to perform various computational operations, e.g., from basic multiplication and accumulation to more complex functions. The number and capability of MAC units 112 may vary by implementation, with configurations ranging from four to thirty-two units being common examples. MAC units 112 can support multiple precision formats (for example, 4-bit, 8-bit, 16-bit operations) and various operational modes, including Single Instruction Multiple Data (SIMD) execution where a single command triggers parallel execution across all units within a device.

Vector interfaces 114 provide input paths for vector data into MAC units 112. These interfaces can support different data widths and formats, enabling flexible handling of input vectors. Vector accumulators 116 couple to MAC units 112 in each PIM DRAM 108 and can be configured with varying bit widths and accumulation depths based on application requirements.

The system supports sophisticated execution models across different hierarchical levels. Within each PIM DRAM 108, SIMD execution enables efficient parallel processing across MAC units. Across different PIM DRAM devices 108, Multiple Instruction Multiple Data (MIMD) execution allows independent operations to proceed in parallel, which are managed through software orchestration via spawn and synchronization mechanisms controlled by ML processor 102.

Memory controllers 106 implement complex coordination mechanisms to manage both traditional memory access as well as processing-in-memory operations. This can include specialized command scheduling, resource allocation, and synchronization across multiple devices. The architecture enables significant bandwidth improvements compared to traditional approaches by minimizing data movement between memory and processing units. In operation, system 100 can handle diverse computational workloads by distributing operations across multiple PIM DRAM devices 108. Data structures may be partitioned and distributed across DRAM banks 110 in various ways depending on application requirements. The architecture supports different scaling approaches, from small embedded systems to large computational arrays, while maintaining the benefit of performing computations close to data storage.

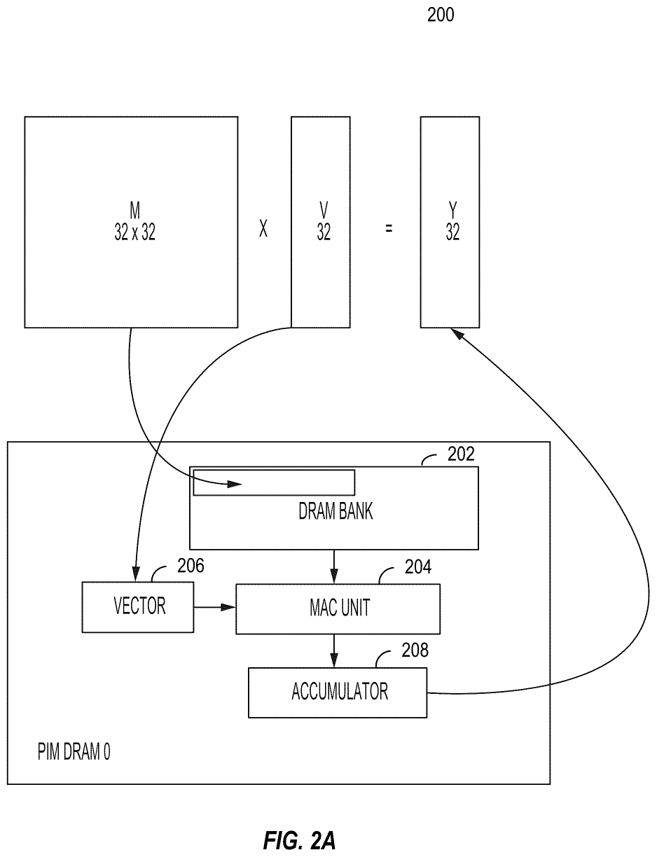

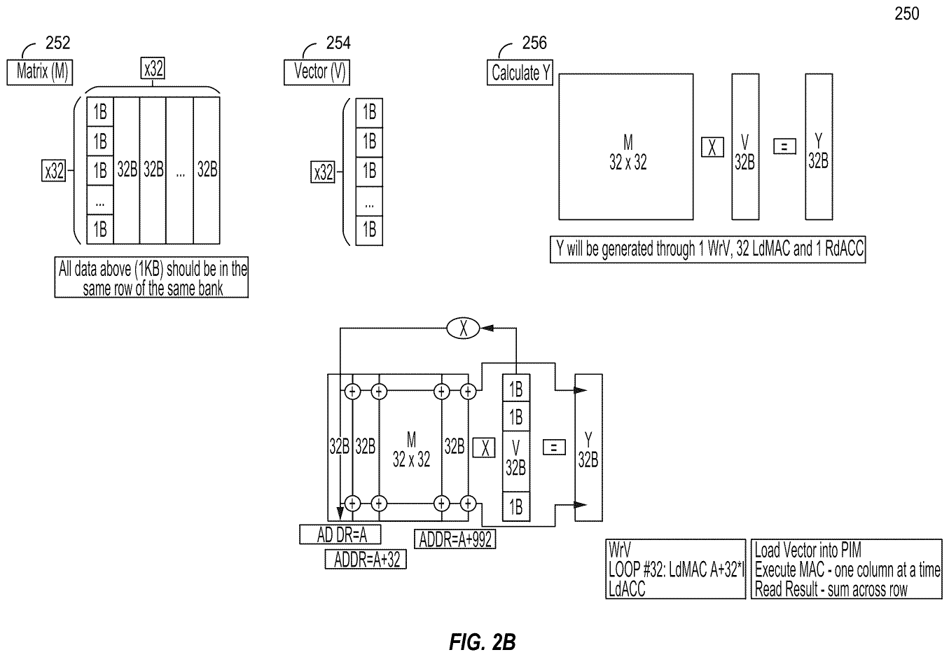

FIGS. 2A and 2B illustrate processing-in-memory operation fundamentals that can support efficient matrix computations, including block quantization techniques for neural network processing, according to aspects described herein. FIG. 2A shows a basic PIM DRAM architecture 200 while FIG. 2B illustrates the corresponding operational flow 250 of matrix-vector multiplication within the architecture.

Referring to FIG. 2A, a PIM DRAM architecture 200 can include a DRAM bank 202 configurable to store matrix data, such as neural network weight matrices. In mobile or resource-constrained systems, these weights may be stored in reduced precision formats, such as 4-bit values, to minimize memory footprint. A MAC unit 204 can couple to DRAM bank 202 and may process matrix values along with vector inputs. Vector register 206 can provide storage for input vectors and may couple to MAC unit 204. An accumulator 208 can couple to MAC unit 204 and may store operation results.

FIG. 2B details the operational flow 250 of matrix-vector multiplication within architecture 200. A weight matrix M 252 can be arranged as a 32×32 matrix occupying, for example, 1 kilobyte of memory in DRAM bank 202, though other sizes and arrangements may be implemented. An input vector V 254 may comprise 32 elements stored in vector register 206, with the size being configurable based on implementation requirements. The multiplication operation produces a result vector Y 256 that can be stored in accumulator 208.

The operational sequence can begin with a Write Vector (WrV) operation that loads input data into vector register 206. After activating the appropriate DRAM page, the system can perform a series of Load and MAC (LdMAC) operations, processing one matrix column at a time through MAC unit 204. Results may accumulate in accumulator 208 and can be accessed through Load Accumulator (LdACC) operations.

Architecture 200 can support various block quantization techniques that enable efficient processing of large language models and the like. Weight matrices may be organized into blocks, with each block potentially sharing scaling factors that map reduced-precision values to larger numerical ranges. For example, blocks of 32 weights can share a scaling factor, enabling efficient storage while maintaining computational accuracy through appropriate scaling operations.

Multiple block quantization implementations can be realized through this architecture. In one approach, weights may be partitioned into blocks of 32 values sharing a floating-point scale factor, with activation values dynamically quantized to 8-bit precision in similarly-sized blocks. Another approach implements hierarchical quantization by aggregating multiple blocks, e.g., combining eight 32-weight blocks into 256-value superblocks. This hierarchical structure can enable use of reduced 6-bit block scale factors alongside a single floating-point scale factor for the superblock, potentially improving both storage efficiency and computational throughput.

The architecture of FIG. 2A can enable the foregoing quantization approaches through its structured processing capabilities. For example, when implementing hierarchical quantization, DRAM bank 202 can store both weight blocks and their associated scaling factors in an organized layout that matches the computational flow through MAC unit 204. The accumulator 208 can be configured to maintain sufficient precision to handle intermediate results before final scaling operations are applied.

In one implementation, superblock sizes may be increased up to 1024 elements to better balance computational efficiency with accuracy. The architecture can support such scaling through its memory organization and computational paths. Integer arithmetic may be used extensively within the PIM device itself, thereby limiting more complex floating-point operations to final scaling steps performed outside the core computation loop.

The relationship between memory organization and computation shown in FIG. 2B is important for efficient block quantization. The structured addressing pattern (A, A+32, etc.) can enable regular access to both weight values and scaling factors. When processing hierarchical blocks, the system can maintain alignment between weight values and their corresponding scale factors at multiple granularities. This organization may support various computational patterns, from basic matrix-vector multiplication to sophisticated quantized neural network operations.

Architecture 200 can enable several approaches to block quantization, each potentially balancing different system constraints. At least three approaches are described herein. A first approach can emphasize parallel operation through snapshot-based result management. A second approach may internalize scaling operations within the PIM device using dedicated scale registers. A third approach can embed scaling factors directly within the weight matrix structure, potentially enabling efficient sequential access to both weights and their scaling factors. These and other approaches can build upon the architecture and operational flow illustrated in FIGS. 2A and 2B, with various implementations possible depending on system requirements and constraints.

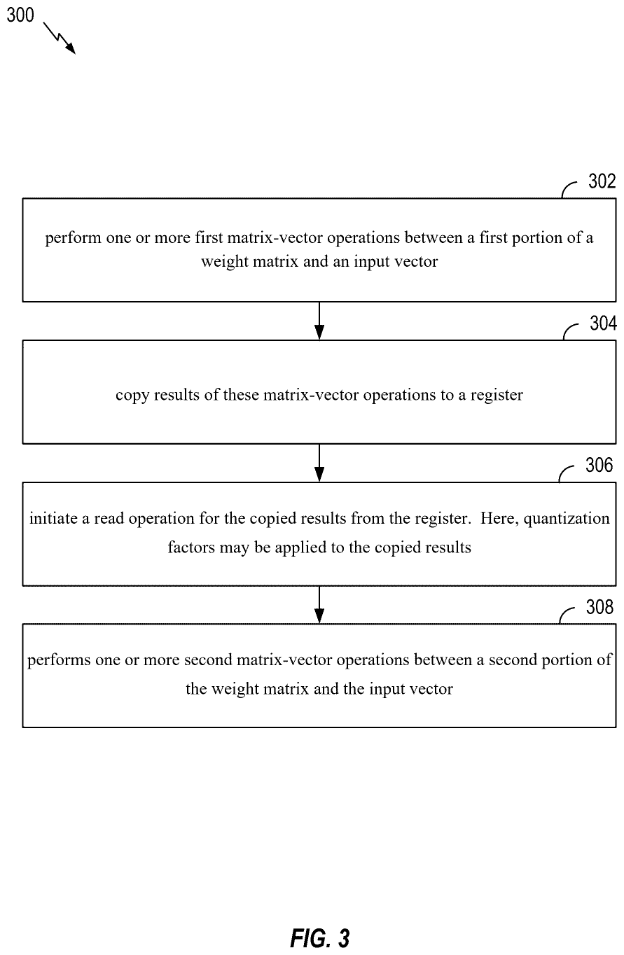

FIG. 3 shows a flowchart illustrating an example process 300 performable by or at a processing-in-memory (PIM) device that supports efficient quantization operations according to aspects described herein. Process 300 provides mechanisms for managing matrix-vector operations and quantization within memory devices. A PIM device can implement process 300 through various hardware and software components working together to perform quantization while maintaining computational efficiency.

At step 302, the PIM device performs one or more first matrix-vector operations between a first portion of a weight matrix and an input vector. In some implementations, the weight matrix may be organized into blocks of different sizes, where smaller blocks (first blocks) can be grouped into larger blocks (second blocks). These second blocks may contain, e.g., between 256 and 1024 values from the weight matrix. Weight values in the matrix can comprise a first bit-width (e.g., 4 bits), while input vector values may use a different bit-width (e.g., 8 bits).

At step 304, the PIM device copies results of these matrix-vector operations to a register. When implemented with an accumulator, copying results to the register may automatically clear the accumulator, preparing it for subsequent operations.

At step 306, the PIM device initiates a read operation for the copied results from the register. Here, quantization factors may be applied to the copied results. Some implementations obtain scaling factors from a scale register associated with the PIM device while others may load scaling factors from dedicated columns interspersed among data columns in the weight matrix at regular intervals.

At step 308, the PIM device performs one or more second matrix-vector operations between a second portion of the weight matrix and the input vector. Here, step 308 can, in some implementations, can be performed in parallel with the read operation initiated in step 306. A multiplier within the PIM device may scale the results of these operations using previously obtained scaling factors.

Throughout process 300, the PIM device manages various aspects of quantization and computational efficiency. For example, when scaling factors are stored in dedicated columns within the weight matrix, the device loads these factors and applies them to operation results within the PIM device itself. Doing so minimizes data movement while maintaining computational accuracy.

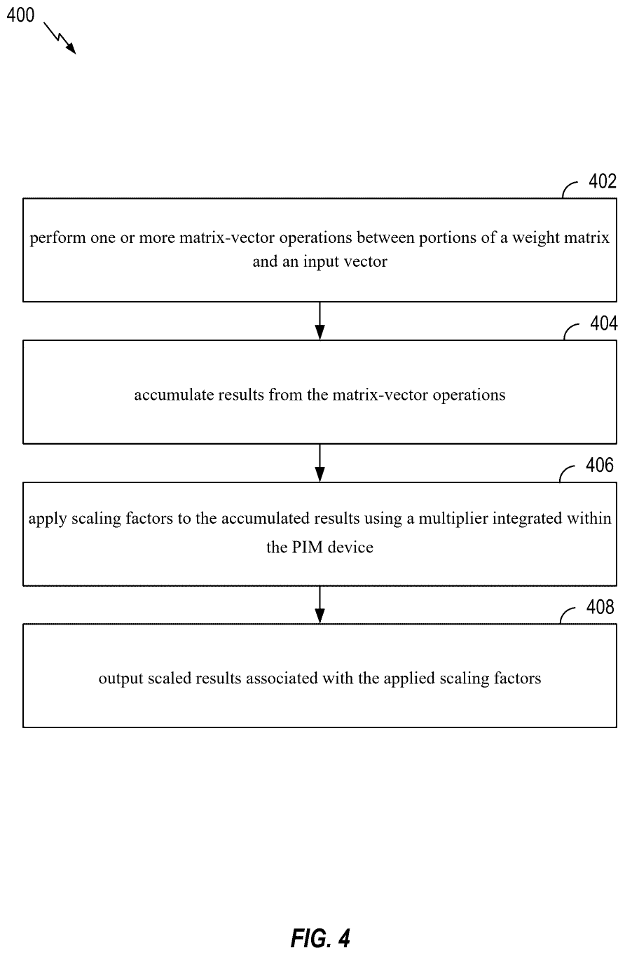

FIG. 4 shows a flowchart illustrating another example process 400 performable by or at a processing-in-memory (PIM) device that supports internal scaling operations according to aspects described herein. As discussed herein, process 400 enables efficient quantization through integrated scaling operations within the memory device itself.

At step 402, the PIM device performs one or more matrix-vector operations between portions of a weight matrix and an input vector. Here, the device can process matrix portions according to predetermined memory access patterns and computational sequences. Matrix values and vector elements can be retrieved from their respective storage locations and combined through multiplication operations in dedicated processing units.

At step 404, the PIM device accumulates results from the matrix-vector operations. In an implementation, an accumulator within the device can maintain running sums of the multiplication results, managing precision requirements through its bit width capacity. Running accumulation allows the device to build complete dot-product results incrementally while minimizing data movement.

At step 406, the PIM device applies scaling factors to the accumulated results using a multiplier integrated within the PIM device. In some implementations, doing so involves sequentially processing entries in the accumulator using the multiplier, where each accumulated value undergoes scaling according to predetermined quantization parameters. The multiplier, which can be implemented as an integer multiplier, can be shared among multiple processing units within the PIM device, enabling efficient resource utilization while maintaining computational accuracy. The sharing mechanism coordinates access to the multiplier through a scheduled sequence of operations.

At step 408, the PIM device outputs scaled results associated with the applied scaling factors. These scaled results can comprise quantized values associated with specific blocks of weight matrix columns. Here, output formatting can include alignment and packaging of the quantized values to match system interface requirements while maintaining the numerical relationships established during processing.

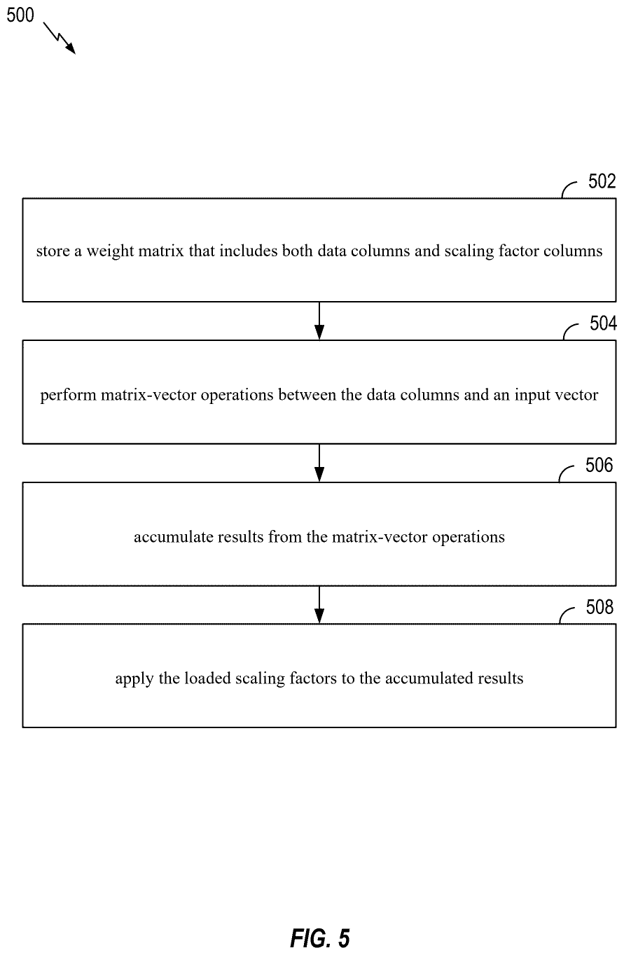

FIG. 5 shows a flowchart illustrating another example process 500 performable by or at a processing-in-memory (PIM) device that supports embedded scaling factor operations according to aspects described herein. Process 500 implements quantization through direct integration of scaling factors within the weight matrix structure to enable efficient access patterns and reduced data movement.

At step 502, the PIM device stores a weight matrix that includes both data columns and scaling factor columns. The data columns may comprise 4-bit weight values while the scaling factor columns may use 32-bit values to maintain necessary precision. According to specific implementations, the device arranges 4 scaling factor columns for every 60 data columns in the matrix-maintaining this ratio throughout the matrix structure to ensure consistent access patterns.

At step 504, the PIM device performs matrix-vector operations between the data columns and an input vector. The input vector may comprise 16-bit integer values, allowing for increased precision in intermediate calculations. Processing units within the device can handle the multiplication and accumulation operations while maintaining appropriate numerical precision.

At step 506, the PIM device accumulates results from the matrix-vector operations. The accumulation process tracks partial results while maintaining sufficient bit width to prevent overflow or precision loss during the computational sequence. During this step, the device also loads scaling factors from the scaling factor columns embedded within the matrix structure. The loading process selects specific scaling factors associated with the current block of data columns being processed, maintaining the relationship between weights and their corresponding scaling factors.

At step 508, the PIM device applies the loaded scaling factors to the accumulated results. This application can proceed through either sequential or parallel processing approaches. In sequential implementations, a multiplier processes accumulated results with corresponding scaling factors in a defined sequence. In parallel implementations, multiple integer multipliers within the PIM device operate simultaneously on different portions of the accumulated results, potentially reducing processing time overhead to approximately 7% through parallel operation.

The scaled results produced during process 500 represent quantized output values for blocks of the weight matrix that maintain computational accuracy while enabling efficient processing within the memory device itself. Throughout process 500, the device manages the relationship between data values and their scaling factors through the embedded matrix structure, thereby eliminating the need for external scaling factor storage or transmission.

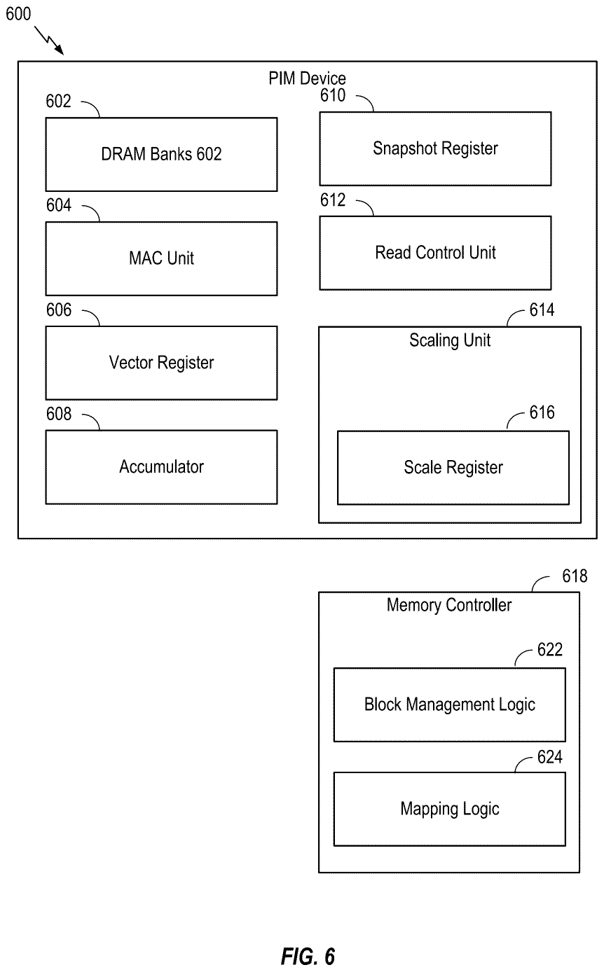

FIG. 6 illustrates a block diagram of a processing-in-memory (PIM) device 600 configured to perform process 300 for quantization using snapshot-based parallel processing. Device 600 includes one or more DRAM banks 602 configured to store weight matrices and input vectors. Each DRAM bank 602 couples to a MAC unit 604 through a data bus that enables transfer of matrix portions and vector data. MAC unit 604 performs matrix-vector multiplication operations on data retrieved from DRAM bank 602.

Device 600 includes a vector register 606 configured to store input vectors during processing. An accumulator 608 couples to MAC unit 604 through a dedicated path and accumulates results from matrix-vector operations. A snapshot register 610 connects to accumulator 608 and can store copies of accumulator contents, enabling parallel processing of subsequent operations while previous results are being read. When implemented to support different bit-widths, MAC unit 604 includes circuitry configured to process weight values of a first bit-width (e.g., 4 bits) and input vector values of a second bit-width (e.g., 8 bits).

A read control unit 612 manages read operations from snapshot register 610. Control unit 612 can initiate reads of copied results while MAC unit 604 continues processing new matrix-vector operations. A scaling unit 614 couples to read control unit 612 and can apply quantization factors to results read from snapshot register 610. Scaling unit 614 includes a scale register 616 that can store scaling factors either received through an external interface or loaded from dedicated columns within the weight matrix.

Memory controller 618 coordinates operations across device 600 through a control bus. Controller 618 includes block management logic 622 that can arrange matrix data into hierarchical blocks of different sizes. For example, matrix data may be organized into first blocks of a first size and second blocks of a second size, where second blocks may comprise between 256 and 1024 values. When implementing interspersed scaling factors, mapping logic 624 within controller 618 tracks scaling factor columns positioned at regular intervals among data columns.

In operation, device 600 performs process 300 by first loading portions of a weight matrix from DRAM banks 602 and input vectors through vector register 606 (step 302). MAC unit 604 performs matrix-vector operations with results accumulating in accumulator 608. When a block of computations completes, accumulator 608 copies its contents to snapshot register 610 (step 304), automatically clearing itself for subsequent operations. While read control unit 612 retrieves results from snapshot register 610 (step 306), MAC unit 604 can process the next block of matrix-vector operations in parallel (step 308), enabling efficient pipelined computation.

It should be appreciated that device 600 includes means for performing steps to execute process 300. In one implementation, device 600 includes means for performing first matrix-vector operations between a weight matrix portion and an input vector, implemented by MAC unit 604 operating with DRAM banks 602. The device 600 further includes means for copying operation results to a register, implemented by accumulator 608 operating in conjunction with snapshot register 610. Means for initiating read operations for copied results is performed by read control unit 612 executing with memory controller 618. The device 600 also includes means for performing second matrix-vector operations in parallel with the read operation, implemented by MAC unit 604 operating while read control unit 612 processes previous results. Finally, means for applying quantization factors to copied results is implemented by scaling unit 614 operating with scale register 616.

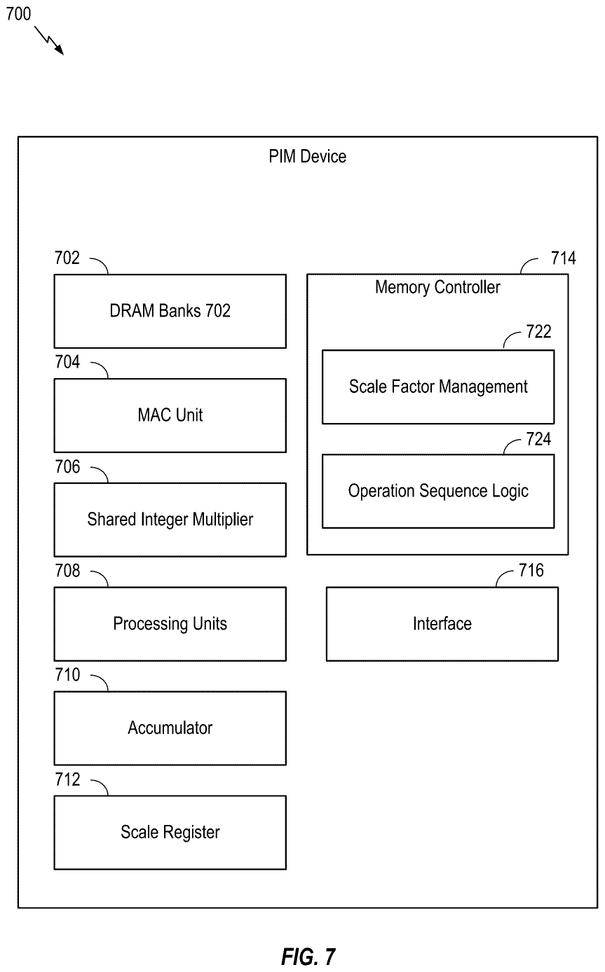

FIG. 7 illustrates a block diagram of a PIM device 700 configured to perform process 400 for quantization using internal scaling. Device 700 includes DRAM banks 702 configured to store weight matrices and input vectors. A MAC unit 704 couples to DRAM banks 702 through data paths and includes a shared integer multiplier 706 that serves multiple processing units 708.

An accumulator 710 connects to MAC unit 704 and stores operation results for scaling. Scale register 712 provides scaling factors to the shared integer multiplier 706, enabling sequential processing of accumulated values. The shared integer multiplier 706 can be time-shared among processing units 708 to maximize resource utilization while maintaining computational accuracy. Memory controller 714 coordinates data movement and operations across device 700. Memory controller 714 manages the sequencing of matrix-vector operations and subsequent scaling operations to ensure proper synchronization between computation and scaling phases. Interface unit 716 enables communication with external processors and receipt of scaling parameters.

Memory controller 714 can include scale factor management logic 722 configured to coordinate downloading of scaling factors into the PIM device and manage their distribution to scale register 712. Operation sequencing logic 724 within controller 714 can coordinate the sharing of integer multiplier 706 among processing units 708 and managing the sequential processing of accumulated results through the shared multiplier.

In operation, device 700 performs process 400 by executing matrix-vector operations through MAC unit 704 (step 402), accumulating results in accumulator 710 (step 404). Shared multiplier 706 then applies scaling factors to accumulated results (step 406) with final scaled results output through interface unit 716 (step 408).

It should be appreciated that device 700 includes means for performing steps to execute process 400. In one implementation, device 700 includes means for performing matrix-vector operations between weight matrix portions and an input vector, implemented by MAC unit 704 operating with DRAM banks 702. The device includes means for accumulating operation results performed by accumulator 710 executing with MAC unit 704. Means for applying scaling factors to accumulated results is performed by shared integer multiplier 706 operating in conjunction with multiple processing units 708. The device also includes means for outputting scaled results associated with scaling factors, implemented by memory controller 714 coordinating with interface unit 716.

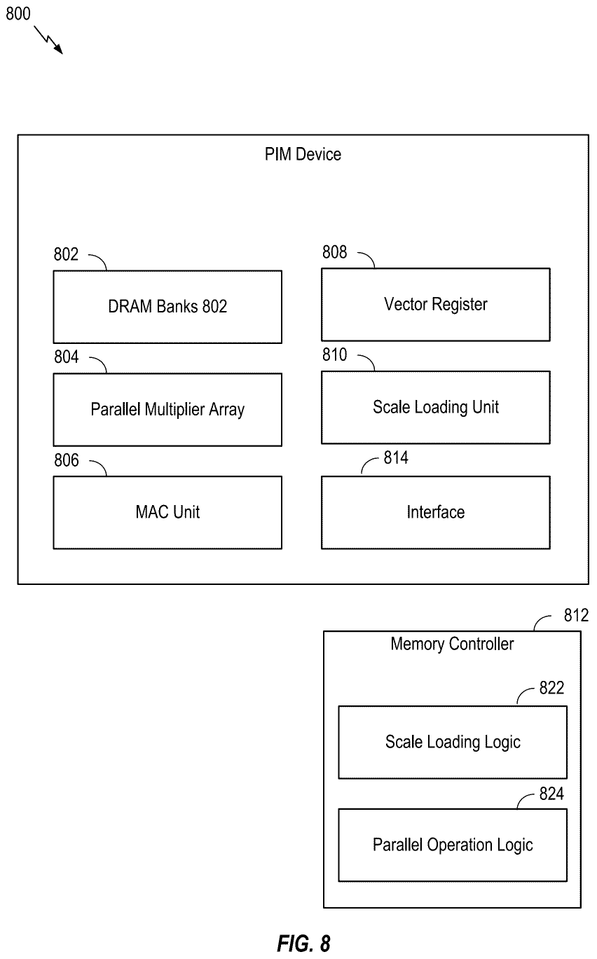

FIG. 8 illustrates a block diagram of a PIM device 800 configured to perform process 500 for quantization using embedded scaling factors. Device 800 includes DRAM banks 802 configured to store both weight matrix data and scaling factors in an interleaved arrangement. An array of parallel multipliers 804 enables simultaneous processing of multiple scaling operations.

MAC units 806 can support various bit-width combinations for matrix-vector operations, such as, e.g., INT4×INT8 operations. MAC units 806 connect to a vector register 808 that may be configured for various bit-width storage arrangements, such as 32×8b storage in some implementations. A scale loading unit 810 manages the retrieval and distribution of scaling factors embedded within the DRAM banks 802. Memory controller 812 coordinates operations and maintains the relationship between data columns and their associated scaling factors.

Memory controller 812 can include scale loading logic 822 configured to manage the loading of scaling factors from DRAM banks 802 and coordinate their distribution through scale loading unit 810. Parallel operation logic 824 within controller 812 can coordinate the simultaneous operation of multiple multipliers within parallel multiplier array 804 and manage timing and data flow to achieve efficient parallel scaling operations.

The parallel multiplier array 804 can include multiple multipliers operating simultaneously. In one implementation, for example, the array includes 32 INT8×INT8 multipliers, though other quantities and configurations of multipliers may be implemented. This parallel operation capability can significantly reduce scaling operation overhead. Interface unit 814 enables external communication and control signal reception from an ML processor or other controller.

In operation, device 800 performs process 500 by first storing the weight matrix with embedded scaling factors in DRAM banks 802 (step 502). MAC units 806 perform matrix-vector operations (step 504) with results accumulating in dedicated registers (step 506). Scale loading unit 810 retrieves scaling factors, which parallel multipliers 804 apply to accumulated results (step 508). Through parallel operation, the system can achieve reduced overhead, such as approximately 7% in some implementations.

It should be appreciated that device 800 includes means for performing steps to execute process 500. Device 800 includes means for storing a weight matrix with embedded scaling factors, implemented by DRAM banks 802 operating under control of memory controller 812. Means for performing matrix-vector operations is performed by MAC units 806 executing with vector register 808, where the MAC units can be configured to support various operational bit-widths. The device includes means for accumulating operation results and loading scaling factors performed by scale loading unit 810 operating in conjunction with MAC units 806. Means for applying loaded scaling factors to accumulated results is implemented by parallel multiplier array 804 executing under coordination of memory controller 812, where the multiplier array can be configured to support various quantities and arrangements of parallel multipliers. The device can also include means for performing parallel multiplication of accumulated results with loaded scaling factors using multiple multipliers within the PIM device, implemented through the coordinated operation of parallel multiplier array 804 with scale loading unit 810 and memory controller 812.

In one or more aspects, techniques for quantization in processing-in-memory devices may include additional aspects, such as any single aspect or any combination of aspects described below or in connection with one or more other processes described elsewhere herein. Additionally, an apparatus may perform or operate according to one or more aspects as described below. In some implementations, the apparatus includes a processing-in-memory device. In some implementations, the apparatus includes at least one processor and a memory coupled to the processor. The processor may be configured to perform operations described herein with respect to the apparatus. In some other implementations, the apparatus may include a non-transitory computer-readable medium having program code recorded thereon, the program code being executable by a computer for causing the computer to perform operations described herein. In some implementations, the apparatus may include one or more means configured to perform operations described herein.

In a first aspect, a method of quantization in a processing-in-memory (PIM) device includes performing one or more first matrix-vector operations between a first portion of a weight matrix and an input vector in the PIM device, copying results of the one or more first matrix-vector operations to a register, initiating a read operation for the copied results from the register, and performing one or more second matrix-vector operations between a second portion of the weight matrix and the input vector in parallel with the read operation.

In a second aspect, in combination with the first aspect, the method includes applying a quantization factor to the copied results read from the register.

In a third aspect, in combination with one or more of the first aspect through the second aspect, the weight matrix is organized into one or more first blocks of a first size, and wherein one or more of the first blocks are grouped into one or more second blocks of a second size, the second size being larger than the first size.

In a fourth aspect, in combination with one or more of the first aspect through the third aspect, at least one of the one or more second blocks comprises between 256 and 1024 values from the weight matrix.

In a fifth aspect, in combination with one or more of the first aspect through the fourth aspect, the weight matrix comprises weight values of a first bit-width, and the input vector comprises values of a second bit-width different from the first bit-width.

In a sixth aspect, in combination with one or more of the first aspect through the fifth aspect, the first bit-width is 4 bits and the second bit-width is 8 bits.

In a seventh aspect, in combination with one or more of the first aspect through the sixth aspect, the method includes obtaining one or more scaling factors in a scale register associated with the PIM device, and scaling the results of the one or more second matrix-vector operations using a multiplier within the PIM device.

In an eighth aspect, in combination with one or more of the first aspect through the seventh aspect, the weight matrix includes one or more data columns and one or more scaling factor columns, and the method includes loading one or more scaling factors from the one or more scaling factor columns, and applying the loaded scaling factors to a result of the one or more second matrix-vector operations within the PIM device.

In a ninth aspect, in combination with one or more of the first aspect through the eighth aspect, the scaling factor columns are interspersed among the data columns at regular intervals.

In a tenth aspect, in combination with one or more of the first aspect through the ninth aspect, copying the results to the register clears an accumulator used for the one or more first matrix-vector operations.

In an eleventh aspect, a method for quantization in a PIM device includes performing one or more matrix-vector operations between one or more portions of a weight matrix and an input vector, accumulating results of the matrix-vector operations, applying one or more scaling factors to the accumulated results using a multiplier in the PIM device, and outputting one or more scaled results associated with the one or more scaling factors.

In a twelfth aspect, in combination with one or more of the first aspect through the eleventh aspect, applying the one or more scaling factors comprises sequentially processing entries in an accumulator using the multiplier.

In a thirteenth aspect, in combination with one or more of the first aspect through the twelfth aspect, the multiplier comprises an integer multiplier shared among multiple processing units in the PIM device.

In a fourteenth aspect, in combination with one or more of the first aspect through the thirteenth aspect, the scaled results comprise quantized values associated with a block of weight matrix columns.

In a fifteenth aspect, a method for quantization in a PIM device includes storing a weight matrix in the PIM device, the weight matrix including one or more data columns and one or more scaling factor columns, performing one or more matrix-vector operations between the one or more data columns and an input vector, accumulating results of the one or more matrix-vector operations, loading scaling factors from the one or more scaling factor columns, and applying the loaded scaling factors to the accumulated results within the PIM device.

In a sixteenth aspect, in combination with one or more of the first aspect through the fifteenth aspect, applying the loaded scaling factors comprises using a multiplier to sequentially process the accumulated results with corresponding scaling factors.

In a seventeenth aspect, in combination with one or more of the first aspect through the sixteenth aspect, the input vector comprises 16-bit integer values.

In an eighteenth aspect, in combination with one or more of the first aspect through the seventeenth aspect, the one or more data columns of the weight matrix comprise 4-bit weight values and the one or more scaling factor columns comprise 32-bit values.

In a nineteenth aspect, in combination with one or more of the first aspect through the eighteenth aspect, the one or more scaling factor columns are interspersed among the one or more data columns at regular intervals of 60.

In a twentieth aspect, in combination with one or more of the first aspect through the nineteenth aspect, the method includes selecting scaling factors from the one or more scaling factor columns associated with a current block of data columns being processed.

In a twenty-first aspect, in combination with one or more of the first aspect through the twentieth aspect, applying the loaded scaling factors is associated with quantized output values for a block of the weight matrix.

In a twenty-second aspect, in combination with one or more of the first aspect through the twenty-first aspect, the one or more scaling factor columns comprise 4 columns for every 60 data columns in the weight matrix.

In a twenty-third aspect, in combination with one or more of the first aspect through the twenty-second aspect, the method includes performing parallel multiplication of the accumulated results with the loaded scaling factors using multiple integer multipliers within the PIM device.

In a twenty-fourth aspect, an apparatus includes at least one memory storing instructions and one or more processors configured to perform any of the methods of the first aspect through the twenty-third aspect.

In a twenty-fifth aspect, a non-transitory computer-readable medium storing instructions executable by a processor comprises instructions causing the processor to perform any of the methods of the first aspect through the twenty-third aspect.

In a twenty-sixth aspect, the apparatus of the twenty-fourth aspect includes means for performing any of the methods of the first aspect through the twenty-third aspect.

In a twenty-seventh aspect, in combination with one or more of the first aspect through the twenty-sixth aspect, the method includes performing integer operations within the PIM device and converting results using a single scaling factor.

twenty-seventh aspect, the method includes dividing the weight matrix into groups of different sizes, where larger groups comprise multiple smaller groups, and applying different scaling factors to each group size.

In a twenty-ninth aspect, in combination with one or more of the first aspect through the twenty-eighth aspect, the method includes applying scaling factors of different bit-widths to different sized portions of the weight matrix.

In a thirtieth aspect, in combination with one or more of the first aspect through the twenty-ninth aspect, the method includes arranging the weight matrix into portions of increasing size, with each larger portion comprising multiple smaller portions, and applying scaling factors hierarchically from smaller portions to larger portions.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it should be appreciated that throughout this disclosure, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as, e.g., “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or algorithm disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc wherein disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method for quantization in a processing-in-memory (PIM) device, comprising:
performing one or more first matrix-vector operations between a first portion of a weight matrix and an input vector in the PIM device;
copying results of the one or more first matrix-vector operations to a register;
initiating a read operation for the copied results from the register; and
performing one or more second matrix-vector operations between a second portion of the weight matrix and the input vector in parallel with the read operation.

2. The method of claim 1, further comprising:
applying a quantization factor to the copied results read from the register.

3. The method of claim 1, wherein the weight matrix is organized into one or more first blocks of a first size, and wherein one or more of the first blocks are grouped into one or more second blocks of a second size, the second size being larger than the first size.

4. The method of claim 3, wherein at least one of the one or more second blocks comprises between 256 and 1024 values from the weight matrix.

5. The method of claim 1, wherein the weight matrix comprises weight values of a first bit-width, and the input vector comprises activation values of a second bit-width different from the first bit-width.

6. The method of claim 5, wherein the first bit-width is 4 bits and the second bit-width is 8 bits.

7. The method of claim 1, further comprising:
obtaining one or more scaling factors in a scale register associated with the PIM device; and
scaling the results of the one or more second matrix-vector operations using a multiplier within the PIM device.

8. The method of claim 1, wherein the weight matrix includes one or more data columns and one or more scaling factor columns, and the method further comprises:
loading one or more scaling factors from the one or more scaling factor columns; and
applying the loaded scaling factors to a result of the one or more second matrix-vector operations within the PIM device.

9. The method of claim 8, wherein the scaling factor columns are interspersed among the data columns at regular intervals.

10. The method of claim 1, wherein copying the results to the register clears an accumulator used for the one or more first matrix-vector operations.

11. A method for quantization in a processing-in-memory (PIM) device, comprising:
performing one or more matrix-vector operations between one or more portions of a weight matrix and an input vector;
accumulating results of the matrix-vector operations;
applying one or more scaling factors to the accumulated results using a multiplier in the PIM device; and
outputting one or more scaled results associated with the one or more scaling factors.

12. The method of claim 11, wherein applying the one or more scaling factors comprises:
sequentially processing entries in an accumulator using the multiplier.

13. The method of claim 11, wherein the multiplier comprises an integer multiplier shared among multiple processing units in the PIM device.

14. The method of claim 11, wherein the scaled results comprise quantized values associated with a block of weight matrix columns.

15. A method for quantization in a processing-in-memory (PIM) device, comprising:
storing a weight matrix in the PIM device, the weight matrix including one or more data columns and one or more scaling factor columns;
performing one or more matrix-vector operations between the one or more data columns and an input vector;
accumulating results of the one or more matrix-vector operations;
loading scaling factors from the one or more scaling factor columns; and
applying the loaded scaling factors to the accumulated results within the PIM device.

16. The method of claim 15, wherein applying the loaded scaling factors comprises:
using a multiplier to sequentially process the accumulated results with corresponding scaling factors.

17. The method of claim 15, wherein the input vector comprises 16-bit integer values.

18. The method of claim 15, wherein the one or more data columns of the weight matrix comprise 4-bit weight values and the one or more scaling factor columns comprise 32-bit values.

19. The method of claim 15, wherein the one or more scaling factor columns are interspersed among the one or more data columns at regular intervals of 60.

20. The method of claim 15, further comprising:
selecting scaling factors from the one or more scaling factor columns associated with a current block of data columns being processed.

21. The method of claim 15, wherein applying the loaded scaling factors is associated with quantized output values for a block of the weight matrix.

22. The method of claim 15, wherein the one or more scaling factor columns comprise 4 columns for every 60 data columns in the weight matrix.

23. The method of claim 15, further comprising:
performing parallel multiplication of the accumulated results with the loaded scaling factors using multiple integer multipliers within the PIM device.
